(19) United States
(12) Patent Application Publication
(10) Pub. No.: US 2021/0322835 A1
(43) Pub. Date: Oct. 21, 2021

(54) CORN HOLE BAG COLLECTOR

(71) Applicant: SEAN MCCORMICK, SUFFOLK, VA (US)

(72) Inventor: SEAN MCCORMICK, SUFFOLK, VA (US)

(21) Appl. No.: 17/232,143

(22) Filed: Apr. 15, 2021

Related U.S. Application Data
(60) Provisional application No. 63/011,244, filed on Apr. 16, 2020.

(51) Int. Cl. A63B 47/02; A63B 67/06; A63B 63/08

(52) U.S. Cl. CPC A63B 47/021; A63B 2210/50; A63B 63/08; A63B 67/06

(57) ABSTRACT

Described herein is a corn hole or bean bag collector or retrieval system which includes a retrieval basket and carriage moved by a conveyor belt and drive system, as well as a push button control system. This system further includes one or more lifting arms and a basket storage container. This system is compact, portable, adjustable, and battery-operated or AC wall outlet powered.

### CLAIM OF PRIORITY

This application claims priority to and the benefit of U.S. Provisional Application with Ser. No. 63/011,244, filed on Apr. 16, 2020, titled CORN HOLE BAG COLLECTOR, the contents of which are hereby incorporated by reference in its entirety.

### FIELD OF THE INVENTION

The inventive concept relates generally to a corn hole bag collector.

### BACKGROUND

Currently there are several solutions for retrieving corn hole bags. One of these solutions attempts to bend down and pick up the bags, but this solution fails to meet the needs of the market because the user may not be physically able. Another solution attempts to utilize having someone else to pick up the bags, but this solution is similarly unable to meet the needs of the market because it is inconvenient. Still another solution seeks to utilize tongs, but this solution also fails to meet market needs because there may not be one available. Therefore, there currently exists a need in the market for an apparatus that picks up corn hole bags during and after a corn hole bag game.

### SUMMARY OF THE INVENTION

The inventive concept relates generally to a corn hole bag or bean bag collector system that is compact and portable. Furthermore, it would also be advantageous to have an apparatus that is battery operated or electrically operated on a wall outlet. Still further, it would be advantageous to have an apparatus that is adjustable for different user needs and that picks up corn hole bags.

The inventive concept advantageously fills the aforementioned deficiencies by providing a corn hole bag (or bean bag) collector, which provides a way to pick up bags for users who may not be physically able to retrieve corn hole bags from the ground using a retrieving basket and a conveyor belt system. The apparatus fulfills the need for corn hole retrieving machine.

In one example embodiment there is provided a bean bag toss or corn hole bag retrieval system that is designed to be placed under a bean bag toss board with a hole and support legs at one end. The retrieval system includes a frame member including a concave platform portion and a cover member coupled at one end via a hinge, the concave portion including a storage portion and a first conveyor portion, the cover member including a retrieval carriage configured from a back plate coupled to side plates which are hingeably coupled to a set retrieval lifting arms, the retrieval carriage being moveable by a second conveyor portion longitudinally upward along the cover member. The system further includes at least one retrieval basket adapted to be moved by a first conveyor belt to the retrieval carriage and lifting arms coupled to a second conveyor belt of the second conveyor portion, the retrieval basket further adapted to be stored in the storage portion during transport. In addition, a push button control system is included on the frame member that is designed to independently control the first and second conveyor belts, wherein the push button control system engages the retrieval arms and basket and moves the basket up to a proximal end of the cover member. Finally, the retrieval system includes a power supply module operatively coupled to the push button control system and a drive system powering the first and second conveyor belts.

In a related example embodiment there is provided corn hole or bean bag toss retriever system designed to be placed under a bean bag toss board game. The retrieval system includes a frame member including a concave platform portion and a cover member coupled at one end via a hinge, the concave portion including a first conveyor portion, the cover member including a carriage retrieval device adapted to be moved longitudinally along the cover member by a second conveyor portion. In addition, a retrieval control system is included that independently controls the first and second conveyor belts and independently controls movement of the carriage retrieval device longitudinally along the cover member. The system also includes a power supply module located on the frame member and operatively coupled to the push button control system and operatively coupled to a drive system of each of the first and second conveyor portions.

In a related embodiment, the retriever system further includes at least one retrieval basket or tray wherein the at least one retrieval basket is moved by the first conveyor portion towards a set of retrieval arms of the retrieval carriage device operatively coupled to a second conveyor belt of the second conveyor portion. In yet another related embodiment, the frame member includes rollers or wheels to facilitate portability and transport of the frame member when in storage.

Among other things, it is an advantage of the inventive concept to provide a corn hold bag collector that does not suffer from any of the problems or deficiencies associated with prior solutions. It is still further an advantage of the inventive concept to be portable. Still further, the apparatus has a button control for raising and lowering the basket.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete and will fully convey the full scope of the inventive concept to those skilled in the art.

### BRIEF DESCRIPTION OF THE DRAWINGS

FIG. 1 illustrates a top view of the corn hole bag retrieving system or device.

FIG. 2 illustrates a right side view of the retrieval device.

FIG. 3 illustrates a left side view of the retrieval device.

FIG. 4 illustrates a perspective view of retrieval device.

FIG. 5 illustrates a second perspective view of the retrieval device.

FIG. 6 illustrates a front view of the retrieval device.

FIG. 7 illustrates a bottom view of the retrieval device.

FIG. 8 illustrates a rear or back view of the folded corn hole bag retrieval system or device.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The inventive concept is a corn hole bag collector kit or system which includes a battery-operated corn hole bag (or bean bag toss item) retrieving device. In a related embodiment, the retrieval device may be directly powered by alternating current or a solar panel with battery-backup, and is not necessarily limited to battery only operation.

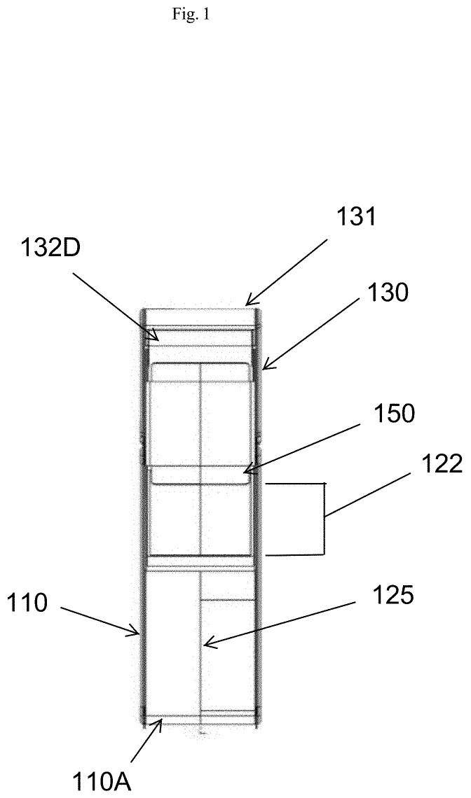

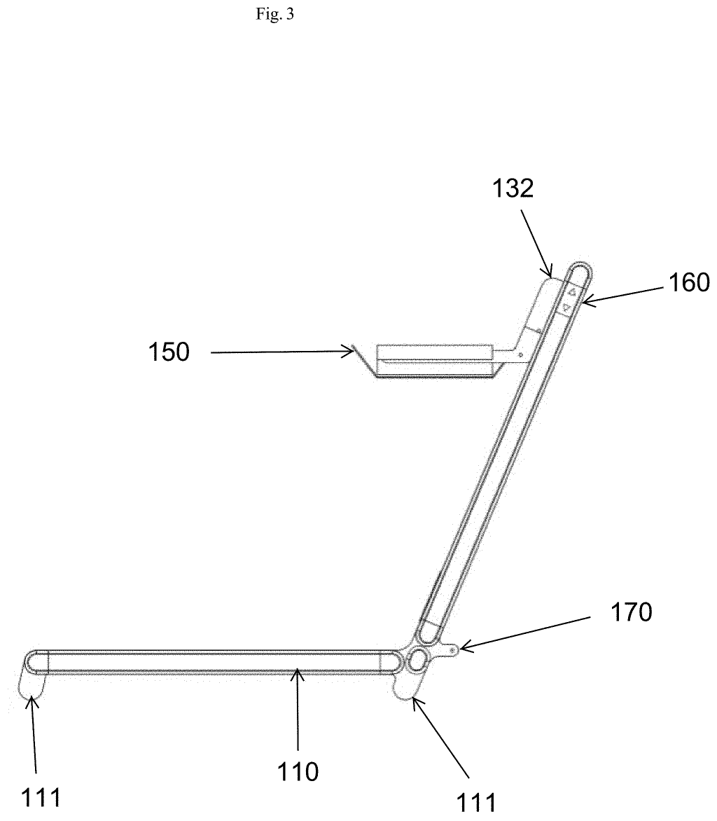

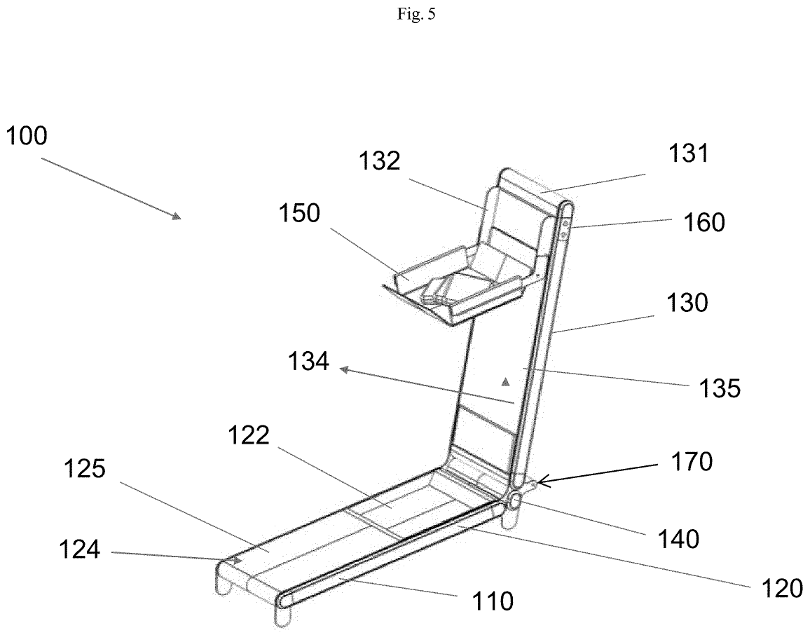

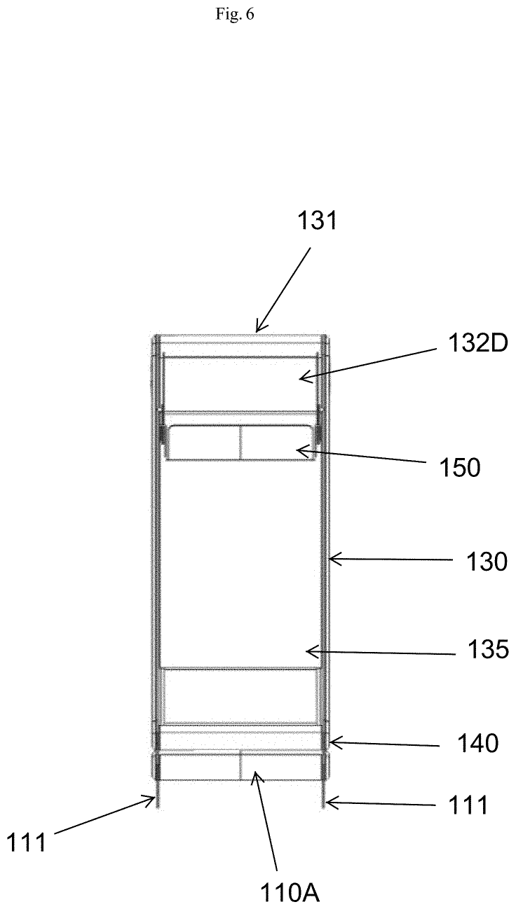

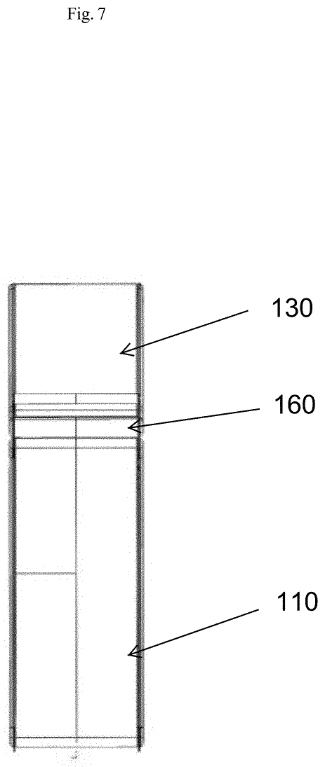

Referring to the FIGS. 1-8, and in particular FIGS. 1, 2, 4, 5, there is illustrated a corn hole or bean bag toss board 10 with a hole 10A and upright supporting legs 11 used together with a set of bean bags 12 used with an inventive corn hole bag retriever system 100. In one example embodiment, corn hole bag retrieval system 100 includes a frame member 110 supported by a set of upright legs 111 (in a related embodiment legs 111 pivot towards frame member 110 for a more compact configuration for portability). Frame member 110 further includes a concave platform portion 120 and a cover member 130 hingably coupled at one proximal end 131A via a hinge 140.

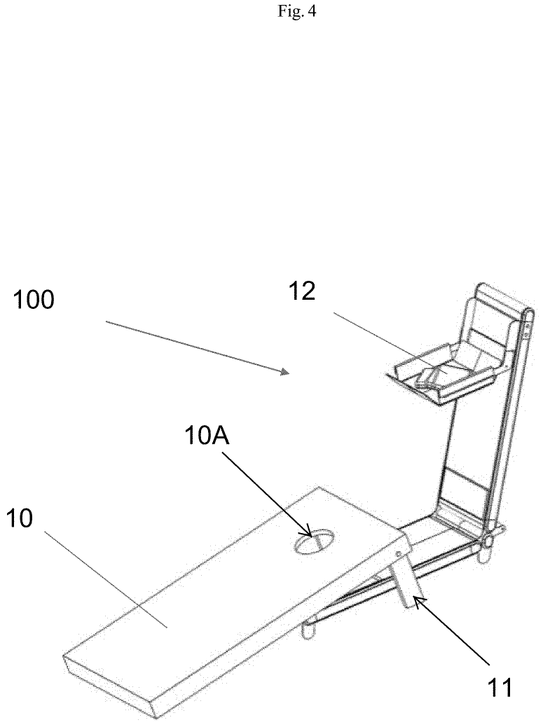

Referring to FIG. 4, concave platform portion 120 of frame member 110 is designed to be located underneath a corn hole game board 10 for retrieval of corn bags 12. Concave portion 120 of frame member 110 includes a storage portion 122 and a first conveyor portion 124 configured from a rolling belt or band 125 and power rolling assembly (not shown). In this example embodiment, storage portion 122 is configured to store at least one retrieval basket or tray 150 supported by a portion of cover member 130. Basket or tray 150 is configured to catch or receive bean bags or corn hole bags 12 falling through hole 10A of game board 10.

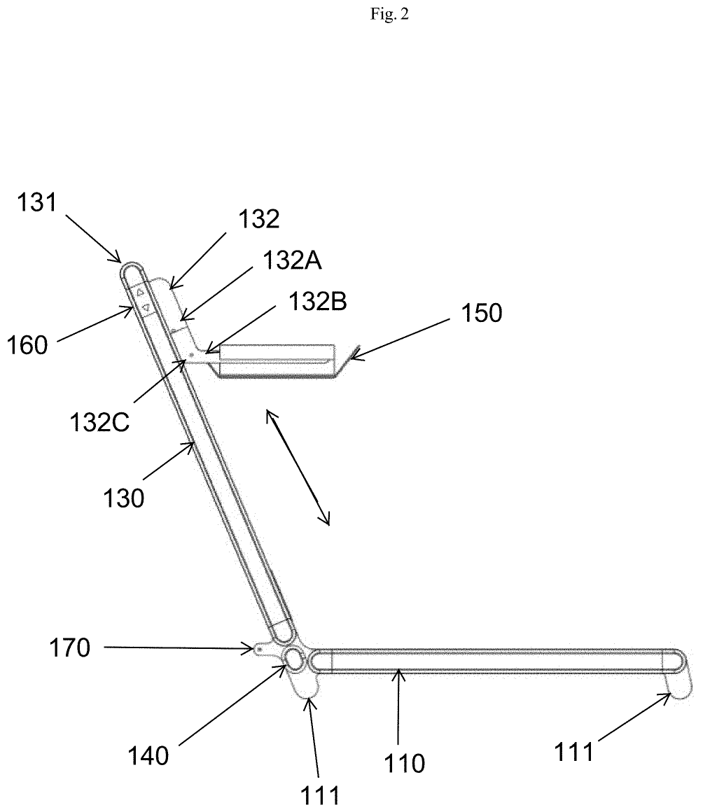

In this example embodiment, the cover member 130 includes a retrieval carriage 132 which includes a back plate 132D coupled to a set of side support plates 132A hingeably coupled to a set of retrieval lifting arms 132B via a hinge 132CA. In operation, lifting arms 132B are designed to be in contact with and to lift tray 150, tray(s) 150 being designed to be moveable by a second conveyor portion 134 longitudinally upward (and downward, see directional arrow FIG. 2) along the cover member 130. In this example embodiment, as users or players use retrieval system 100 under bean bag toss board 10, the at least one retrieval basket 150 is designed to be moved laterally by first conveyor belt 125 from a distal end 131B of concave member 120 towards retrieval arms 132 that are coupled to second conveyor belt 135 of the second conveyor portion 134. One or more retrieval baskets 150 are further designed to capture bean bags anywhere along the surface of conveyor portion 134 and to store basket(s) 150 in the storage portion 122 of concave portion 120 during transport.

In this example embodiment, the corn hole bag retrieval system 100 further includes a push button control system 160 designed to independently control a drive mechanism (not shown) for each of conveyor portions 124 and 134 coupled respectively to first and second conveyor belts 125 and 135. Push button control system 160 also independently engages retrieval arms 132A of retrieval carriage 132 so as to engage basket 150 (which may or may not have the bean bags) and move the basket up to a proximal end 131 of the cover member 130 for benefit of the user.

In this example embodiment, retrieval system 100 also includes a power supply unit 170 for powering drive systems (not shown) of the conveyor systems 124 and 134. Included within unit 170 is an AC/DC conversion circuit module and a battery for providing AC wall outlet power use and a battery for power storage and back up power when the unit is not plugged into a wall outlet. Although the embodiments show a push button control system 160, such can be provided as a Bluetooth wireless control option via a separate handheld remote or via a smartphone applet.

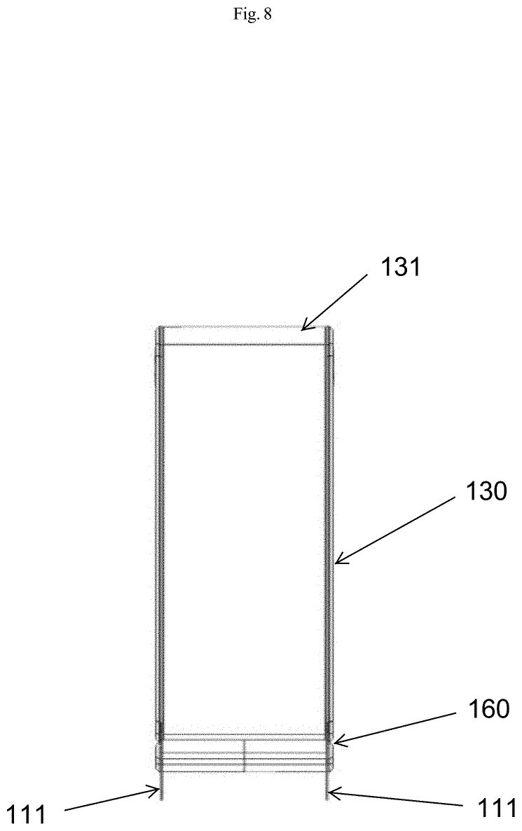

Although not shown here and referring to FIG. 8, retrieval arms 132B are foldable inward towards cover member 130. In a related embodiment, arms 132B can extend outward and lie flat within cover member 130 for storage. Frame portion 110 and the cover member 130 are designed to close and mate in a clam configuration for storage and portability.

The following patents are incorporated by reference in their entireties: U.S. Pat. Nos. 7,607,666; 4,938,485; and 7,762,914.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A corn hole or bean bag toss retriever system comprising:
a frame member including a concave platform portion and a cover member coupled at one end via a hinge, the concave portion including a first conveyor portion, the cover member including a carriage retrieval device adapted to be moved longitudinally along the cover member by a second conveyor portion;
a retrieval control system adapted to independently control the first and second conveyor belts and to independently control movement of the carriage retrieval device longitudinally along the cover member; and
a power supply module located on the frame member and operatively couple d to the push button control system and operatively coupled to a drive system of each of the first and second conveyor portions.

2. The retriever system of claim 1, further comprising at least one retrieval basket or tray wherein the at least one retrieval basket is moved by the first conveyor portion towards a set of retrieval arms of the retrieval carriage device operatively coupled to a second conveyor belt of the second conveyor portion.

3. The retriever system of claim 1, wherein the retrieval basket further adapted to be stored in a storage portion in the concave portion during transport.

4. The retriever system of claim 2, wherein the control system is a push button control system adapted to independently control the first and second conveyor belts, wherein the push button control system engages the retrieval arms and basket and moves the basket up to a proximal end of the cover member.

5. The retriever system of claim 1, wherein the control system includes a wireless receiver adapted to receive wireless transmissions from at least one of a remote controller or a smartphone applet installed in a smartphone.

6. The retriever system of claim 2, wherein the power supply includes a battery to provide DC power to the drive systems of the conveyor portions and to the retrieval arms of the carriage device.

7. The retriever system of claim 1, wherein the power supply module is adapted to operate from energy provided by at least one energy source of the group consisting of AC power, DC power and solar power via solar cells.

8. The retriever system of claim 1 wherein the concave platform portion is adapted to be located underneath a corn hole game board for retrieval of corn hole or bean bags.

9. The retriever system of claim 2 wherein the retrieval arms are foldable and the concave portion and the cover member are adapted to close and mate in a clam configuration for storage and portability.

10. A bean bag toss or corn hole bag retrieval system comprising:
a frame member including a concave platform portion and a cover member coupled at one end via a hinge, the concave portion including a storage portion and a first conveyor portion, the cover member including a retrieval carriage configured from a back plate coupled to side plates which are hingeably coupled to a set retrieval lifting arms, the retrieval carriage being moveable by a second conveyor portion longitudinally upward along the cover member;
at least one retrieval basket adapted to be moved by a first conveyor belt to the retrieval carriage and lifting arms coupled to a second conveyor belt of the second conveyor portion, the retrieval basket further adapted to be stored in the storage portion during transport;
a push button control system adapted to independently control the first and second conveyor belts, wherein the push button control system engages the retrieval arms and basket and moves the basket up to a proximal end of the cover member; and
a power supply module operatively coupled to the push button control system and a drive system powering the first and second conveyor belts.

11. The retriever system of claim 10, wherein the power supply module is adapted to operate from energy provided by at least one energy source of the group consisting of AC power, DC power and solar power via solar cells.

12. The retriever system of claim 10, wherein the push button control system includes a wireless receiver adapted to receive wireless transmissions from at least one of a remote controller or a smartphone applet installed in a smartphone.

13. The retriever system of claim 1 comprising a kit including a bean bag toss board and a set of bean bags.

14. The retriever system of claim 10 wherein the frame member includes rollers or wheels to facilitate portability and transport of the frame member when in storage or stored configuration.

15. The retriever system of claim 1 wherein the frame member includes rollers or wheels to facilitate portability and transport of the frame member when in storage or in a stored configuration.
